(19) United States
(12) Patent Application Publication
(10) Pub. No.: US 2006/0072738 A1
(43) Pub. Date: Apr. 6, 2006

(54) Dialoguing rational agent, intelligent dialoguing system using this agent, method of controlling an intelligent dialogue, and program for using it

(76) Inventors: Vincent Louis, Ploubezre (FR); Franck Panaget, Trebeurden (FR); Philippe Bretier, Trelevern (FR)

Correspondence Address: FISH & RICHARDSON P.C., PO BOX 1022, MINNEAPOLIS, MN, 55440-1022, US

(21) Appl. No.: 11/238,136

(22) Filed: Sep. 27, 2005

(30) Foreign Application Priority Data
Sep. 27, 2004 (FR) 0410210

(51) Int. Cl. H04M 3/00; H04M 5/00

(52) U.S. Cl. 379/265.02; 379/266.07

(57) ABSTRACT

A rational agent includes interpretation means to transform events translating a communication activity of an external agent into incoming formal records, a rational unit producing outgoing formal records as a function of the incoming formal records and a behavioral model of the rational agent, and outgoing events generation means transforming outgoing formal records into outgoing events materializing a communication activity of the rational agent with the external agent. The interpretation means comprise several interpretation modules, each of which is dedicated to a mode specific to it, and the rational agent also comprises an inputs and outputs management layer provided with a multimodal fusion module that takes account of all incoming events, redirects their interpretation to the different interpretation modules concerned, correlates incoming formal records and submits the incoming formal communication records thus correlated to the rational unit.

### CROSS REFERENCE TO RELATED APPLICATION

This application claims the benefit of French Patent Application Serial No. 04 10210, filed Sep. 27, 2004, the contents of which are hereby incorporated by reference in its entirety.

### TECHNICAL FIELD

This invention relates in general to automation of a communication method.

More precisely, according to a first of its aspects, the invention relates to a dialoguing rational agent comprising a software architecture including at least means of interpreting incoming events, a rational unit, and means of generating outgoing events, the interpretation means being designed to transform incoming events translating a communication activity of an external agent into incoming formal communication records, during operation, the rational unit producing outgoing formal communication records as a function of the incoming formal communication records during operation and a behavioral model of the rational agent managed by the rational unit, and also during operation the generation means transforming outgoing formal communication records into outgoing events materializing a communication activity of the rational agent with the external agent.

### BACKGROUND

A rational agent of this type is well known to those skilled in the art and is described in the basic patent FR 2 787 902 by the same applicant.

The technique proposed in this basic patent relates to intelligent dialogue systems used in a natural language by rational agents, both in an interaction context between an intelligent dialogue system and a user, or in the context of an interaction between an intelligent dialogue system and another software agent of an intelligent dialogue system with several agents.

In the first case the dialogue is carried out in a natural language, while in the second case it can be carried out directly in a formal logical language such as the language known under the acronym “ArCoL” divulged in the above mentioned patent, or the language known under the acronym “FIPA-ACL” developed by the FIPA (Foundation for Intelligent Physical Agents) consortium. Information about this consortium can be found on the Internet site http://www.fipa.org).

However, the basic patent mentioned above does not define any specific means of performing a dialogue in which at least the external agent can express itself in several ways, for example both in his or her natural language and by pressing buttons and/or performing specific sign language.

However, attempts to formalize multimodal dialogues have been undertaken so as to allow a dialogue between an automated rational agent and an external agent, for example a human user, expressing himself using non-verbal modes (in other words not using natural language, for example through a sign language or haptic interfaces), or using several different modes simultaneously and/or successively, each communication mode being related to a particular information channel as is the case for a written message, an oral message, an intonation, a drawing, a sign language, touch sensitive information, etc.

A user could thus express himself simultaneously by voice and sign language using an appropriate interface, it being understood that the rational agent could also use several different modes to express itself to make its reply to the user.

Such multimodal interactions require the use of two operations, namely multimodal fusion and multimodal fission.

Multimodal fusion is the operation by which one or several multimodal event interpretation components at the input to the intelligent dialogue system produce a unified representation of the semantics of perceived messages.

Multimodal fission, which is only required if the rational agent needs to express itself in several different modes independently of the manner in which the external agent expresses himself, is the dual multimodal fusion operation and, for one or several multimodal event generation components, consists of generating the said events to express the semantic representation of the message produced by the rational unit of the rational agent.

Attempts to formalize multimodal dialogues include the work done by the MMI group in the W3C standardization organization that, in the lack of a functional architecture, proposed a tool for representing the multimodal inputs and outputs of an interaction system based on a mark-up language called EMMA (Extensible MultiModal Annotation Mark-up Language) and related to the XML language, except that the existing tool is only capable of representing the inputs.

It is also worth mentioning the work done by the VoiceXML group in the W3C organization in contact with the MMI group, and the work done by the MPEG consortium that originated the MPEG-7 project that provides a mechanism for adding descriptive elements to a multimodal content, and the MPEG-21 project with the objective of proposing a standard framework for multimodal interaction.

However, although many systems use multimodal fusion and/or fission components, these components are usually the result of empirical integrations of processing capabilities of several media, and are not the result of the use of a predefined software architecture.

In particular, although the work done by the MMI group describes a tool for representing multimodal input and output flows, accompanied by an abstract architecture for the organization of components (see W3C Multimodal Interaction Framework—W3C NOTE 06 May 2003—http://www.w3.org/TR/2003/NOTE-mmi-framework-20030506/), this work has not yet led to any specific mechanism for the interpretation of multimodal inputs or for the generation of multimodal outputs by the rational intelligent dialogue agent.

### SUMMARY

In this context, and while the above mentioned patent FR 2 787 902 only considers interactions based on the use of the natural language between the user and the intelligent dialogue system (comprehension and generation) and the use of formal communication languages like ArCoL or FIPA-ACL between software agents (one of them possibly being an intelligent dialogue system), the main purpose of this invention is to propose a software architecture that would allow the dialoguing rational agent to generically manage multimodal interactions with its contacts, that may be human users or other software agents.

To achieve this purpose, the dialoguing rational agent according to the invention that is conform with the generic definition given in the above preamble, is characterized essentially in that the software architecture also comprises an inputs and outputs management layer provided with at least one multimodal fusion module, and in that the interpretation means comprise a plurality of incoming event interpretation modules, each module being specifically dedicated to a particular communication mode, in that during operation all incoming events are handled by the multimodal fusion module that redirects interpretation of these incoming events to the various interpretation modules as a function of the mode of each, and in that the multimodal fusion module correlates incoming formal communication records collected from these interpretation modules during the same fusion phase, and submits the incoming formal communication records thus correlated to the rational unit at the end of the fusion phase.

Preferably, the fusion module redirects interpretation of incoming events by transmitting any incoming event expressed in the mode specific to this interpretation module to the interpretation module concerned, with a list of objects, if any, previously evoked in previous incoming events in the same fusion phase, and a list of formal communication records returned by the call from the previous interpretation module during the same fusion phase.

To achieve this, each interpretation module called by the fusion module returns, for example, a list of objects completed and updated to include any new evoked object or to modify any object evoked in the last incoming event, and a list of formal communication records translating the communication activity represented by all incoming events received since the beginning of the same fusion phase.

Advantageously, the fusion module includes a fusion phase management stack accessible in read and in write for all interpretation modules and for the fusion module.

Symmetrically, the invention also relates to a dialoguing rational agent comprising a software architecture including at least means of interpreting incoming events, a rational unit, and means of generating outgoing events, the interpretation means being designed so that during operation they can transform incoming events translating a communication activity of an external agent into incoming formal communication records, and during operation the rational unit generating outgoing formal communication records as a function of the incoming formal communication records, and a behavioral model of the rational agent managed by the rational unit, and generation means transforming the outgoing formal communication records into outgoing events materializing a communication activity of the rational agent with regard to the external agent, this agent being characterized in that the inputs and outputs management layer is provided with a multimodal fission module, in that the generation means comprise a plurality of modules generating outgoing events, each of which is specifically dedicated to a communication mode specific to it, in that the multimodal fission module redirects transformation of outgoing formal communication records generated by the rational unit as outgoing events with corresponding modes to the different generation modules, and in that the multimodal fission module manages the flow of these outgoing events.

For example, the fission module redirects transformation of outgoing formal records into outgoing events by sequentially addressing to the different generation modules the outgoing formal communication records generated by the rational unit and a tree structure to be completed, organized into branches, each of which will represent one of the outgoing events, each generation module then returning the tree structure to the fission module after having completed it with the outgoing event(s) expressed in the mode specific to this generation module.

Preferably, the tree structure is a mark-up structure, and each generation module uses a tag common to all generation modules to identify the same object evoked in an outgoing event.

It is also useful to allow for at least one of the generation modules to be designed to selectively call a generation module previously called by the fission module for a new processing, so as to transmit a new partial structure to it containing the outgoing event generated by the calling generation module and no longer containing the outgoing event previously generated by the called generation module.

If the rational agent comprises multimodal fusion modules and fission modules, the multimodal interpretation and generation modules for a particular mode preferably belong to the same processing module for this mode.

The invention also relates to an intelligent dialogue system comprising at least one dialoguing rational agent like that previously defined, associated with a multimodal communication interface.

The invention also relates to a method for controlling an intelligent dialogue between a controlled rational agent and an external agent, this method comprising at least interpretation operations consisting of interpreting incoming events supplied to the controlled rational agent by transforming them into incoming formal communication records, determination operations consisting of generating appropriate responses to the incoming formal communication records in the form of outgoing formal communication records, and expression operations consisting or transforming outgoing formal communication records to produce outgoing events addressed to the external agent, this method being characterized in that it also comprises switching operations, correlation operations and phase management operations, in that at least one switching operation consists of taking account of at least one incoming event as a function of a mode of expression of this incoming event, in that the operations to interpret incoming events expressed in the corresponding different modes are used separately, in that at least one correlation operation consists of collecting the incoming formal communication records corresponding to different modes of incoming events, during the same fusion phase, for joint processing of these incoming formal communication records by the same determination operation, and in that phase management operations consist of at least determining at least one fusion phase.

For example, phase management operations include at least one operation to update a stack or a list of objects for management of closure of the fusion phase consisting of selectively storing one or several new objects in the stack during an interpretation operation, to indicate the expected appearance of one or several new events before the end of the fusion phase, and selectively removing one or several objects from the stack during an interpretation operation in the case in which the corresponding expected events are no longer expected before the end of the fusion phase.

Furthermore, phase management operations can also include a stack viewing operation consisting of selectively viewing all objects in the stack during an interpretation operation.

Phase management operations can also include a timing operation consisting of selectively removing a delay type object from the stack, setting a timeout for the duration of this delay, and viewing the stack when this delay has elapsed.

Phase management operations may include an operation to close the fusion phase consisting of terminating the fusion phase after the interpretation operations, when the stack is empty.

The invention also relates to a method for control of an intelligent dialogue between a controlled rational agent and an external agent, this method comprising at least interpretation operations consisting of interpreting incoming events output to the controlled rational agent by transforming them into incoming formal communication records, determination operations consisting of generating appropriate responses to incoming formal communication records in the form of outgoing formal communication records, and expression operations consisting of transforming outgoing formal communication records to produce outgoing events addressed to the external agent, this method being characterized in that it also includes a concatenation operation consisting of at least applying expression operations associated with corresponding different output modes to the outgoing formal communication records sequentially, and producing a tree structure organized in branches, each of which represents one of the outgoing events, each expression operation completing this tree structure with modal information specific to this expression operation.

Preferably, the concatenation operation produces a tree structure with tags, and at least some of the expression operations associated with different corresponding output modes use a common tag to evoke the same object invoked in an outgoing event.

Each expression operation can also be designed so that it calls another expression operation already called during the same concatenation operation and to have an outgoing event previously generated by this other expression operation modified by this other expression operation in the tree structure being constructed.

Finally, the invention relates to a computer program containing program instructions for implementing the previously defined method when this program is installed on computer equipment for which it is intended.

Other characteristics and advantages of the invention will become clear after reading the following description that is given for guidance and is in no way limitative, with reference to the attached drawings.

### DESCRIPTION OF DRAWINGS

FIG. 1 is a diagram showing the architecture of a dialoguing rational agent according to the invention;

FIG. 2 is a flowchart showing the logical and chronological organization of operations involved during a multimodal fusion phase; and

FIG. 3 is a flowchart representing the logical and chronological organization of the operations involved during a multimodal fission phase.

Like reference symbols in the various drawings indicate like elements.

### DETAILED DESCRIPTION

As mentioned previously, the invention is in the domain of multimodal interaction systems, and more particularly in components for the interpretation of multimodal events at system inputs (fusion components) and generation of multimodal events at the output (fission components).

In this context, this invention proposes a software architecture using the formal architecture described in the basic patent mentioned above for multimodal interactions.

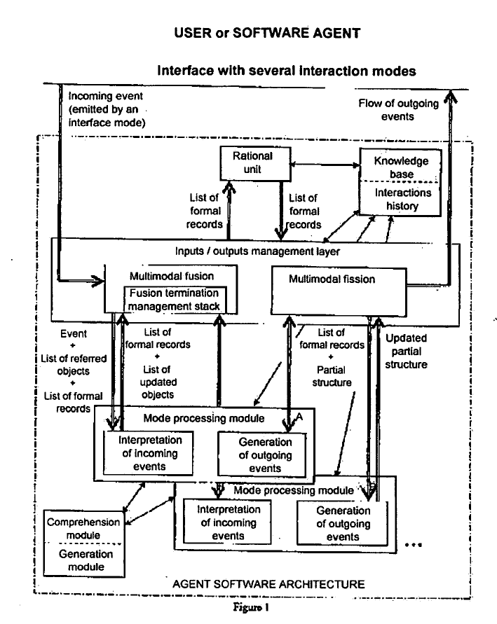

As shown in FIG. 1, this architecture comprises:
an inputs and outputs management layer that organizes processing of incoming events and the production of outgoing events within the dialoguing rational agent (see below);
a number of processing modules, each of which is related to an interaction mode specific to it and that processes events expressed in this mode. The choice of this type of modules to be used depends directly on the different communication modes available in the user or software agent interfaces with which the rational agent is required to interact;
a rational unit like that described in the basic patent mentioned above, that has the function of calculating the reactions of the rational agent, by logical inference with the formal model axioms of this agent;
a knowledge base and a history of interactions as described in the above mentioned basic patent, and which can be accessed by the inputs/outputs management layer, the rational unit and the processing modules mentioned above; and
comprehension and generation modules like those described in the above mentioned basic patent, that if necessary are used by modules for processing of events related to linguistic modes (for example resulting from speech recognition, or messages input by the user on the keyboard).

The central element of this new architecture is the inputs/outputs management layer that organizes reception and sending of events outside the rational agent, and processing of these events within the agent and their distribution between the different modules.

This processing is organized in three steps or phases, comprising a multimodal fusion phase, a reasoning phase and a multimodal fission phase.

During the multimodal fission phase, all incoming events are interpreted to form a list of formal communication records that formally represent communication records accomplished by the external agent that sent these events, namely a human user or another software agent. These records are expressed in a formal logical language like that used in the above mentioned basic patent (called ArCoL, for Artimis Communication Language), or like the FIPA-ACL language, that is a language normalized by the FIPA consortium based on the ArCoL language.

During the reasoning phase, formal communication records are transmitted to the rational unit that calculates an appropriate reaction of the dialoguing rational agent in the form of a new list of formal communication records, this calculation being done using the information in the above mentioned patent known to those skilled in the art, in other words by logical inference based on axioms of the formal behavioral model of the rational agent.

Finally, during the multimodal fission phase, the formal communication records previously generated by the rational unit are transformed into events for the different available modes in the multimodal communication interface with the external agent (user or software agent).

In the special case in which only interactions between the rational agent and other software agents are envisaged (therefore the other software agents are not human users), modules for processing events associated with the interpretation and generation of messages expressed in a formal inter-agent communication language such as FIPA-ACL are implanted in this software architecture. From the point of view of the rational agent that uses the intelligent dialogue system, the use of such a language to communicate with other entities is then seen as being an interaction on a particular mode.

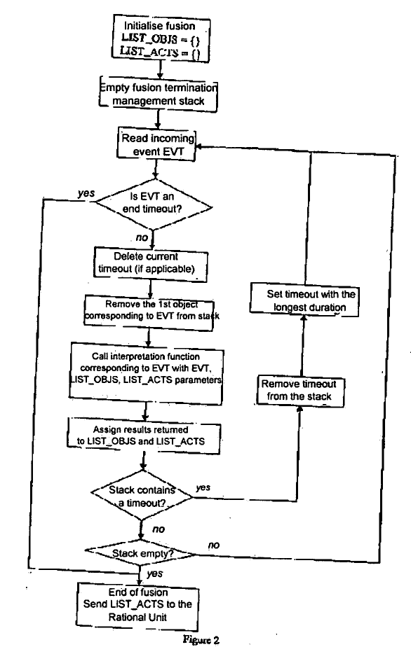

The multimodal fusion mechanism used by the inputs/outputs management layer will be described particularly with reference to FIG. 2.

Incoming events addressed to the rational agent are transmitted separately, mode by mode, through the multimodal interface through which the rational agent dialogues with the external agent (user or another software agent). For example, if the user clicks while he is pronouncing a phrase, two sources produce events sent to the rational agent, namely firstly the touch mode of the user interface that perceives the clicks, and secondly voice mode that implements voice detection and recognition.

Each incoming event received by the inputs/outputs management layer is sent to the processing module associated with the corresponding mode. In the previous example, the rational agent must have two processing modules, one for events related to touch mode, and the other for events related to voice mode.

In general, each processing module associated with a mode is composed of two functions, also called “modules”, namely a function to interpret incoming events that is called during the multimodal fusion phase, and a function to generate outgoing events that is called during the multimodal fission phase, as described later.

Therefore an incoming event will be processed by the interpretation function of the processing module that is associated with the mode in which this event occurs.

This interpretation function receives three arguments, namely:
the incoming event EVT itself;
the list LIST_OBJS of objects already mentioned in the previous incoming events during the same fusion phase (these objects have been identified by the interpretation functions called during the reception of the previous incoming events). This list is empty at the time of the first call to the current multimodal fusion phase; and
the list LIST_ACTS of formal communication records returned by the call to the last interpretation function during the same fusion phase, this list being empty at the time of the first call to the current multimodal fusion phase.

The called interpretation function uses these two elements, and must return two results:
the previous list LIST_OBJS of objects already mentioned, completed and possibly updated by objects evoked in the contents of the incoming event EVT. For each new object added to the list, an internal representation of this object is created in the history of interactions that is shared by all modules in the proposed software architecture (in particular, these representations can be used in formal communication records and made accessible to processing modules associated with other modes and with the rational unit);
the list LIST_ACTS of formal communication records that represent the communication or illocutionary force, of all events received since the beginning of the fusion phase (including the event EVT currently being processed). This list might be empty, which indicates that not all received events can give a satisfactory interpretation of the action of the external agent on the communication interface. The construction of this list will depend entirely on an evaluation made by the interpretation function, and in particular does not necessarily include the list returned by the call to the last interpretation function. The interpretation method must build a list that represents all information transmitted so far to the different interpretation functions of the current fusion phase. It is sensitive to the context of previous interactions and must use information stored in the interactions history.

The inputs and outputs management layer must then have a special algorithm (that might depend on the dialogue applications used) to decide whether or not the current fusion phase is terminated. In other words, this algorithm must answer the question of knowing whether or not it is necessary to wait for an incoming event before the rational unit triggers the reaction calculation.

If this algorithm indicates that other incoming events should arrive, then the inputs and outputs management layer waits for the next incoming event and, as described above, calls the interpretation function associated with this event.

On the other hand, if the algorithm indicates that there is no longer any incoming event to be waited for, the fusion phase terminates and the list of formal communication records returned by the call to the last interpretation function is transmitted to the rational unit.

The basic algorithm proposed in this invention, that could be adjusted as a function of the dialogue applications used, is based on maintenance of a stack managing stopping the fusion phase by the multimodal fusion mechanism of the inputs and outputs management layer. This stack is emptied at the beginning of a fusion phase, and the interpretation function corresponding to the first incoming received event is then called. Fusion terminates as soon as the stack is empty on return from the call to an interpretation function.

This stack actually contains a list of objects representing the different events expected before finishing the fusion phase. These objects can describe the expected events with more or less precision. The most general object will designate any event. A more specific object will designate any event that is to be processed by the processing module for a particular mode. Another more specific object will designate a particular event among events that will be processed by the processing module of a particular mode, etc.

For example, an object designating any event may be stored in a stack, an object designating any event applicable to touch mode, an object designating an event applicable to “click” type touch mode, an event applicable to “click/button pressed” type touch mode, and in this case, an event applicable to “click/button released” type touch mode will correspond to the first three objects but not to the fourth. A particular “delay” type object will also indicate that an event is possible within an indicated delay. This delay allows the rational agent to wait for possible additional events to take into account in the current fusion phase before this phase is effectively closed.

The stack may be made accessible to all interpretation functions in read and write as follows:
an interpretation function—or module—may store a new object in the stack to indicate that it is necessary to wait for a certain event before closing the fusion;
an interpretation function—or module—may remove one or several objects from the stack to indicate that the corresponding expected events are no longer necessary to terminate the fusion; and
an interpretation function—or module—may view all objects in the stack to determine which future events are expected before the fusion can be terminated.

When an incoming event EVT is received, the inputs/outputs management layer removes the first object with a description that satisfies this event from the stack before calling the appropriate interpretation function as described above.

After this function has been executed:
if the stack is empty, the closing algorithm indicates that the fusion is terminated;
if the stack contains a “delay” object, the inputs and outputs management layer removes this object from the stack and sets a timeout with the time indicated by this object, such that once this delay has elapsed, the inputs/outputs management layer once more tests the stack to determine whether or not the fusion is terminated. Any incoming event received after a timeout has been set and before the end of the corresponding delay will cancel this timeout;
otherwise, the closing algorithm indicates that the fusion is not finished and that another incoming event should be awaited.

Once the fusion phase is terminated, the rational unit then calculates the reaction of the rational agent based on principles known to those skilled in the art described in the above mentioned basic patent.

### EXAMPLE

In a restaurant search application, the external agent, in this case a human user, is provided with a touch and voice interface for querying the intelligent dialogue system. Suppose that the user pronounces the sentence “I am looking for an Italian restaurant in this area” at the same time that he or she designates an area on the screen representing the Eiffel Tower, for example either by a mouse click or by touching with his or her finger.

The voice mode of the user interface starts by sending an event to the rational agent indicating speech detection (“the user is beginning to speak”). The inputs/outputs management layer then calls the voice mode interpretation function with the following arguments:
“the user is beginning to speak” incoming event EVT;
a list LIST_OBJS of objects already evoked (for the moment empty because the fusion phase is just beginning);
a list LIST_ACTS of formal communication records returned by the last call to an interpretation function (for the moment empty because the fusion phase is just beginning).

At this stage, the voice mode interpretation function cannot associate any semantic interpretation to this event. However, it does know that a “speech recognition result” type event applicable to voice mode will arrive later. Therefore, this function stores an object in the fusion phase closing management stack indicating that it is necessary to wait for this type of event, and then returns a list of previously evoked objects and a list of empty formal communication records.

The inputs/outputs management layer applies its fusion phase closing algorithm by examining the contents of the stack. Since the stack contains an event type object, the fusion is not complete and puts itself in waiting for a new incoming event.

The touch mode of the interface then sends an incoming event to the rational agent meaning “click on the Eiffel Tower”. Since this event type is not included in the closing management stack of the fusion phase, the inputs/outputs management layer does not modify the stack and calls the touch mode interpretation function with the following arguments:
the “click on the Eiffel Tower” incoming event;
an empty list of previously evoked objects;
the empty list of formal communication records returned by the last call to the voice mode interpretation function.

The touch mode interpretation function then identifies a location type reference to the “Eiffel Tower” object, creates this object in the appropriate structure of the interactions history, then returns a list LIST_OBJS of objects containing only the “Eiffel Tower” object and a list LIST_ACTS of formal communication records. This record list must correspond to the interpretation of the user's message in the context of the current dialogue, assuming that there are no future incoming events. For example, if the dialogue has just started, this list may be reduced to a “QUERY-REF” type record applicable to a restaurant located close to the identified “Eiffel Tower” object, which the rational agent interprets the click as being a restaurant search request in the area designated by the click, if no more information is input. In another context, for example if the intelligent dialogue system has just asked the user where he is at the moment, this list could be reduced to an “INFORM” type record indicating that the user is close to the identified “Eiffel Tower” object. Since the fusion phase closing management stack already indicates that another event is expected, the touch mode interpretation function does not modify it.

The user interface voice mode then sends the “I am looking for an Italian restaurant in this area” incoming event of the “voice recognition result” type to the rational agent. Since this event type is included in the fusion phase closing management stack, the inputs/outputs management layer removes it (therefore the stack is empty) and calls the voice mode interpretation function with the following arguments:
the “I am looking for an Italian restaurant in this area” incoming event;
a list of previously evoked objects containing the “Eiffel Tower” object;
and the list of formal communication records returned by the last call to the touch mode interpretation function, for example a “QUERY-REF” or “INFORM” type record.

The voice mode interpretation function then identifies a question relating to a restaurant type object linked to an “Italian” object of the “specialty” type and an (unknown) object of the “location” type. It examines the list of previously evoked objects, and identifies the unknown object of the “location” type that it has identified to the “Eiffel Tower” type object of the “location” type given in the list. After creating the new objects and modifying the objects already evoked in the appropriate structure in the interactions history, the voice mode interpretation function returns an ordered list of objects composed of an “Eiffel Tower” object of the “location” type, an (unknown) object of the “restaurant” type, and an “Italian” object of the “specialty” type, and a list of formal communication records composed of a single record for example of the “QUERY-REF” type applicable to a restaurant located close to the “Eiffel Tower” type object with “Italian” specialty. Since this interpretation function is not waiting for any other incoming event, it does not modify the fusion phase closing management stack.

After execution of this function, the inputs/outputs management layer examines the stack. Since the stack is now empty, it concludes that the multimodal phase is terminated and transmits the list of interpreted formal communication records and returned by the call to the last interpretation function (in this case a single “QUERY-REF” type record) to the rational unit.

As those skilled in the art will realize, this method would also have been capable of processing the last two incoming events (namely the click and the voice recognition result) if they had been received by the rational agent in the reverse order. In the first step, the voice mode interpretation function would have sent a list of evoked objects composed of an (unknown) object of the “restaurant” type, an “Italian” object of the “specialty” type, an “unknown” object of the “location” type, and a list of formal communication records composed of the same “QUERY-REF” type record as above. After determining that the reference “in this area” designated another action by the user, this interpretation function would have indicated that another incoming event (of any type) was expected, in the fusion phase closing management stack. In the second event, the touch mode interpretation function would have identified the “Eiffel Tower” object of the “location” type that it had recognized, to the (unknown) “location” type object present in the list of previously evoked objects. Therefore the final result of the fusion phase would have been the same.

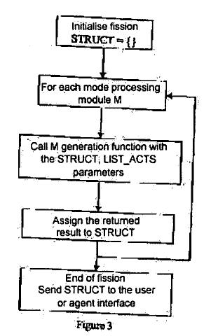

The multimodal fission mechanism used by the inputs/outputs management layer will be described below particularly with reference to FIG. 3.

As indicated above, the multimodal fission mechanism is responsible for constructing a flow of outgoing events addressed to the different user interface modes or the external software agent in contact with the rational agent, starting from formal communication records generated by the rational unit. This construction is based on a tree structure in which each branch uniformly represents one of the generated outgoing events.

For reasons of convenience, it is a good idea to choose an XML type mark-up structure in which each first level tag represents information intended for a mode, each of these items of information may itself be organized into lower level tag (with as many depth levels as necessary) specific to the corresponding mode.

Although in some respects the choice of an XML structure can resemble the use of languages for processing of multimodal events such as the EMMA (Extensible Multimodal Annotation) Mark-up Language standardized by the MMI group in the W3C normalization organization, it is important to remember that the current version of the known architecture is only capable of representing multimodal inputs and emphasize that the main distinguishing feature of the invention is its organization in separate modules for the processing of events related to the different modes, and in its most complete form, by the orchestration of their generation functions.

At the beginning of the multimodal fission phase, the inputs/outputs management layer initializes an empty partial structure STRUCT, that represents the contents of the flow of outgoing events built up to that point during the multimodal fission phase.

The principle is then to transmit the LIST_ACTS list of formal communication records produced by the rational unit, and the current partial structure STRUCT, to each outgoing event generation function—or module—of the processing module associated with each mode available for the output.

Each of these generation functions or modules then returns a new partial structure STRUCT in which the description of the outgoing event intended for the corresponding mode is completed. At the end of the multimodal fission phase, when the inputs/outputs management layer has called all available output mode processing modules, the last returned partial structure represents the complete flow of outgoing events that is effectively transmitted by the rational agent to its contact (user or other software agent) through the communication interface.

Throughout the construction of outgoing events flow in the form of the mark-up structure STRUCT, the generation functions associated with the corresponding possible different output modes use a common tag to identify an object referred to in an output event.

Consequently, if a generation function needs to build an output event that evokes an object already evoked in another mode, then the chronologically second generation function can adapt the generation form of this event taking account of this situation. For example, if the second generation function is related to an expression mode using a natural language, the object evoked for the second time could simply be designated by a pronoun rather than by a complete expression.

Apart from the fact that it has the advantage of being very simple, this fission technique has the advantage that a large number of cases can be processed in which the expressions transmitted to different modes must be synchronized.

On the other hand, it is completely dependent on the order in which the inputs/outputs management layer calls the generation function for each output mode. To prevent this disadvantage from arising, each generation function should itself be allowed to call a generation function that has already been called by the inputs/outputs management layer, and therefore that has left a trace in the partial structure STRUCT, with a new partial structure that contains the event generated by the calling generation function and that no longer contains the event previously generated by the called generation function.

The multimodal fission mechanism proposed in this description is equally suitable for the use of a formal internal language for the representation of communication records received or generated by the rational unit, that associates an illocutionary force (non-verbal communication activity) and a content proportional to each record, as for the use of a richer language also capable of associating modal indications on the illocutionary force and/or the proportional content, such that the rational unit can explicitly reason on the modes used in the observations of the rational agent and on the modes to be used for the reactions of the rational agent.

The type of internal language evoked can represent an “INFORM” type record accomplished on a particular mode or an “INFORM” type record for which part of the proposition content has been expressed in one mode and the other part in another mode.

In the use of such a language, that extends the ArCoL language to make it multimodal, the generation functions for each mode are limited to only producing events in the partial structure STRUCT that translate the part of communication records generated by the rational unit that is intended for the mode corresponding to these events.

### EXAMPLE

In the previous example of the application of the invention for the search for a restaurant, the user has a voice interface and a graphic interface capable of displaying and animating maps, to receive replies from the rational agent. We will assume that the rational agent answers the user's previous question by indicating that there is no Italian restaurant close to the Eiffel Tower but that there is one in a nearby area, this indication being given for example by highlighting this area on the map displayed by the graphic interface by blinking.

The inputs/outputs management layer begins by sending the LIST_ACTS list of formal communication records corresponding to this reply (generated by the rational unit) to the graphic mode generation function. The partial structure STRUCT representing the outgoing events flow is then empty.

The graphic mode generation module then adds a tag into the structure STRUCT to represent an outgoing event intended for the user's graphic interface, for example an order to make the area adjacent to the Eiffel Tower blink. As described above, this module mentions that this event is related to the “other identified location” object of the “location” type, for example by creating an XML structure in the following form:

<outputstream>
<media name = “graphic”> <blink>
<object id = “other location”>
<rectangle_area x = “300” y = “500” height = ”150” width =
“200”/>
</object>
</blink> </media>
</outputstream>

The same formal communication records and this new partial structure STRUCT are then transmitted to the voice mode generation module. In examining the previously built events in the current partial structure, the voice mode generation module observes that the “other identified location” object of the “location” type is already evoked in another mode, and then chooses to use a shifter formulation to designate it, for example “There is no Italian restaurant close to the Eiffel Tower; however, I have found one a bit further away in this area“. The resulting structure returned to the inputs/outputs management layer would then have the following form:

<outputstream>
<media name = “graphic”> <blink>
<object id = “other location”>
<rectangle_area x = “300” y = “500” height = ”150” width =
“200”/>
</object>
</blink> </media>
<media name = “voice”>

There is no Italian restaurant close to the Eiffel Tower; however, I have found one <object id=other location> a bit further away in this area </object>.

</media>
</outputstream>

The inputs/outputs management layer then terminates the multimodal fission phase and sends the flow obtained to the interface that then displays each message on the appropriate channel. The displays invoking the objects shown here by “object” tags must be synchronized by the user interface. For example, the area neighboring the Eiffel Tower must be made to blink while the speech synthesis system pronounces the words “a bit further away in this area”.

A number of embodiments of the invention have been described. Nevertheless, it will be understood that various modifications may be made without departing from the spirit and scope of the invention. Accordingly, other embodiments are within the scope of the following claims.

What is claimed is:

1. A dialoguing rational agent comprising:
a software architecture including at least means of interpreting incoming events, a rational unit, and means of generating outgoing events, the interpretation means being designed to transform incoming events translating a communication activity of an external agent into incoming formal communication records, during operation, the rational unit producing outgoing formal communication records as a function of the incoming formal communication records during operation; and
a behavioral model of the rational agent managed by the rational unit, and also during operation the generation means transforming outgoing formal communication records into outgoing events materializing a communication activity of the rational agent with the external agent;
wherein the software architecture also comprises an inputs and outputs management layer provided with at least one multimodal fusion module; the interpretation means comprise a plurality of incoming event interpretation modules, each module being specifically dedicated to a particular communication mode, in that during operation all incoming events are handled by the multimodal fusion module that redirects interpretation of these incoming events to the various interpretation modules as a function of the mode of each; and the multimodal fusion module correlates incoming formal communication records collected from these interpretation modules during the same fusion phase, and submits the incoming formal communication records thus correlated to the rational unit at the end of the fusion phase.

2. The dialoguing rational agent according to claim 1, wherein the fusion module redirects interpretation of incoming events by transmitting any incoming event expressed in the mode specific to this interpretation module to the interpretation module concerned, with a list of objects, if any, previously evoked in previous incoming events in the same fusion phase, and a list of formal communication records returned by the call from the previous interpretation module during the same fusion phase.

3. The dialoguing rational agent according to claim 2, wherein each interpretation module called by the fusion module returns a list of objects completed and updated to include any new evoked object or to modify any object evoked in the last incoming event, and a list of formal communication records translating the communication activity represented by all incoming events received since the beginning of the same fusion phase.

4. The dialoguing rational agent according to claim 2, wherein the fusion module includes a fusion phase management stack accessible in read and in write for all interpretation modules and for the fusion module.

5. The dialoguing rational agent according to claim 3, wherein the fusion module includes a fusion phase management stack accessible in read and in write for all interpretation modules and for the fusion module.

6. A dialoguing rational agent comprising:
a software architecture including at least means of interpreting incoming events, a rational unit, and means of generating outgoing events, the interpretation means being designed to transform incoming events translating a communication activity of an external agent into incoming formal communication records, during operation, the rational unit producing outgoing formal communication records as a function of the incoming formal communication records during operation; and
a behavioral model of the rational agent managed by the rational unit, and also during operation the generation means transforming outgoing formal communication records into outgoing events materializing a communication activity of the rational agent with the external agent;
wherein the inputs and outputs management layer is provided with a multimodal fission module; the generation means comprise a plurality of modules generating outgoing events, each of which is specifically dedicated to a communication mode specific to it; the multimodal fission module redirects transformation of outgoing formal communication records generated by the rational unit as outgoing events with corresponding modes to the different generation modules; and the multimodal fission module manages the flow of these outgoing events.

7. The dialoguing rational agent according to claim 6, wherein the fission module redirects interpretation of incoming events by transmitting any incoming event expressed in the mode specific to this interpretation module to the interpretation module concerned, with a list of objects, if any, previously evoked in previous incoming events in the same fission phase, and a list of formal communication records returned by the call from the previous interpretation module during the same fission phase.

8. The dialoguing rational agent according to claim 7, wherein each interpretation module called by the fission module returns a list of objects completed and updated to include any new evoked object or to modify any object evoked in the last incoming event, and a list of formal communication records translating the communication activity represented by all incoming events received since the beginning of the same fission phase.

9. The dialoguing rational agent according to claim 7, wherein the fission module includes a fission phase management stack accessible in read and in write for all interpretation modules and for the fission module.

10. The dialoguing rational agent according to claim 8, wherein the fission module includes a fission phase management stack accessible in read and in write for all interpretation modules and for the fission module.

11. The dialoguing rational agent according to claim 6, wherein the multimodal interpretation and generation modules for a particular mode belong to the same processing module for this mode.

12. The dialoguing rational agent according to claim 6, wherein the fission module redirects transformation of outgoing formal records into outgoing events by sequentially addressing the outgoing formal communication records generated by the rational unit and a tree structure to be completed, organized into branches, each of which will represent one of the outgoing events, to the different generation modules, and wherein each generation module returns the tree structure to the fission module after having completed it with the outgoing event(s) expressed in the mode specific to this generation module.

13. The dialoguing rational agent according to claim 12, wherein the tree structure is a mark-up structure, and wherein each generation module uses a tag common to all generation modules to identify the same object evoked in an outgoing event.

14. The dialoguing rational agent according to claim 13, wherein at least one of the generation modules is designed to selectively call a generation module previously called by the fission module for a new processing, so as to transmit a new partial structure to it containing the outgoing event generated by the calling generation module and no longer containing the outgoing event previously generated by the called generation module.

15. An intelligent dialoguing system comprising at least one dialoguing rational agent according to claim 1, associated with a multimodal communication interface.

16. An intelligent dialoguing system comprising at least one dialoguing rational agent according to claim 6, associated with a multimodal communication interface.

17. A method for controlling an intelligent dialogue between a controlled rational agent and an external agent, the method comprising:
at least interpretation operations consisting of interpreting incoming events supplied to the controlled rational agent by transforming them into incoming formal communication records;
determination operations consisting of generating appropriate responses to the incoming formal communication records in the form of outgoing formal communication records; and
expression operations consisting or transforming outgoing formal communication records to produce outgoing events addressed to the external agent;
wherein the method also comprises switching operations, correlation operations and phase management operations, in that at least one switching operation consists of taking account of at least one incoming event as a function of a mode of expression of this incoming event, in that the operations to interpret incoming events expressed in the corresponding different modes are used separately, in that at least one correlation operation consists of collecting the incoming formal communication records corresponding to different modes of incoming events, during the same fusion phase, for joint processing of these incoming formal communication records by the same determination operation, and in that phase management operations consist of at least determining at least one fusion phase.

18. The method according to claim 17, wherein the phase management operations include at least one operation to update a stack or a list of objects for management of closure of the fusion phase consisting of selectively storing at least one new object in the stack during an interpretation operation, to indicate the expected appearance of at least one new event before the end of the fusion phase, and selectively removing one or several objects from the stack during an interpretation operation in the case in which the corresponding expected events are no longer expected before the end of the fusion phase.

19. The control method according to claim 18, wherein the phase management operations also include a stack viewing operation consisting of selectively viewing all objects in the stack during an interpretation operation.

20. The method according to claim 19, wherein the phase management operations also include a timing operation consisting of selectively removing a delay type object from the stack, setting a timeout for the duration of this delay, and viewing the stack when this delay has elapsed.

21. The method according to claim 20, wherein the phase management operations also include an operation to close the fusion phase consisting of terminating the fusion phase after the interpretation operations, when the stack is empty.

22. A method for controlling an intelligent dialogue between a controlled rational agent and an external agent, the method comprising:
at least interpretation operations consisting of interpreting incoming events supplied to the controlled rational agent by transforming them into incoming formal communication records;
determination operations consisting of generating appropriate responses to the incoming formal communication records in the form of outgoing formal communication records; and
expression operations consisting or transforming outgoing formal communication records to produce outgoing events addressed to the external agent;
wherein the method also comprises a concatenation operation consisting of at least applying expression operations associated with corresponding different output modes to the outgoing formal communication records sequentially, and producing a tree structure organized in branches, each of which represents one of the outgoing events, each expression operation completing this tree structure with modal information specific to this expression operation.

23. The method according to claim 22, wherein the concatenation operation produces a tree structure with tags, and wherein at least some of the expression operations associated with different corresponding output modes use a common tag to evoke the same object invoked in an outgoing event.

24. The method according to claim 22, wherein each expression operation is designed so that it calls another expression operation already called during the same concatenation operation and to have an outgoing event previously generated by this other expression operation modified by this other expression operation in the tree structure being constructed.

25. The method according to claim 23, wherein each expression operation is designed so that it calls another expression operation already called during the same concatenation operation and to have an outgoing event previously generated by this other expression operation modified by this other expression operation in the tree structure being constructed.

26. A computer program containing program instructions for implementing the method according to claim 17, when this program is installed on computer equipment for which it is intended.

27. A computer program containing program instructions for implementing the method according to claim 22, when this program is installed on computer equipment for which it is intended.
